(19) United States
(12) Patent Application Publication
(10) Pub. No.: US 2013/0082923 A1
(43) Pub. Date: Apr. 4, 2013

(54) OPTICAL POINTER CONTROL SYSTEM AND METHOD THEREFOR

(71) Applicants: CHUN-HUANG LIN, HsinChu City (TW); Jeng-Feng Lan, HsinChu City (TW)

(72) Inventors: CHUN-HUANG LIN, HsinChu City (TW); Jeng-Feng Lan, HsinChu City (TW)

(73) Assignee: Chip Goal Electronics Corporation, R.O.C.

(21) Appl. No.: 13/251,436

(22) Filed: Oct. 3, 2011

(51) Int. Cl. G06F 3/033

(52) U.S. Cl. 345/157

(57) ABSTRACT

The present invention discloses an optical pointer control system, and a method using in the same system. The system includes: an image display showing a frame having a pointer; a light source generating a light beam; a controller controlling the position of the pointer and including an image sensor receiving the light beam to obtain a image frame having a light spot; and a coordinate transformation processor calculating first coordinates of the light spot in a first coordinate system of the image frame and transferring the first coordinates into second coordinates according to a predetermined second coordinate system; wherein the image display shows the pointer on a corresponding position of the frame according to the second coordinates.

### BACKGROUND OF THE INVENTION

### Field of Invention

The present invention relates to an optical pointer control system and an operation method therefor, in particular to such optical pointer control system and operation method wherein the position of a light spot in an image frame obtained by an image sensor is directly transferred into a corresponding position on a displayed image to determine the pointer's position.

Many current interactive video game systems provide users with joysticks or remote controllers so that the users can play the games by actions, e.g. to drive a race car, to swing a golf club, etc. Such joystick or remote controller typically includes a gyro, an accelerometer, or an image sensor. In a joystick or remote controller which employs the image sensor, the image sensor senses images and generates information for controlling the movement of a cursor or a pointer on a screen, or for selecting an icon to execute a corresponding function or program, etc.

In the prior art, the image sensor receives light beams generated from multiple reference points located in the vicinity of a display, wherein each of the reference points includes several light emitting diodes. Accordingly, each image frame captured by the image sensor is an image including multiple light spots. By comparing previous and next image frames wherein complicated calculation is involved such as identifying features in an image frame and calculating a displacement of the features, the joystick controls the cursor and moves it to a desired location.

U.S. Pat. No. 7,834,848 discloses a prior art technique utilizing images of two references to control a cursor. This prior art is similar to the aforementioned prior art wherein complicated calculation is required, and hence they cannot immediately respond to the instruction of the controller to swiftly move the cursor, and the complicated calculation consumes more power. In another prior art U.S. Pat. No. 5,448,261 which calculates and outputs a relative displacement and moving direction, complicated calculation is also required.

In view of above, the present invention overcomes the foregoing drawbacks by providing an optical pointer control system and a method, which directly transfer or map the position of a light spot in an image frame captured by the image sensor to a corresponding position on the display to determine the location of a pointer. Thus, no complicated calculation is required so that it can shorten the data processing time to immediately respond to an instruction from the controller, and it also reduces power consumption.

### SUMMARY OF THE INVENTION

An objective of the present invention is to provide an optical pointer control system.

Another objective of the present invention is to provide an operation method of an optical pointer control system.

To achieve the foregoing objectives, in one aspect, the present invention provides an optical pointer control system, comprising: an image display showing an image including a pointer; a light source generating at least one light beam; a controller controlling a position of the pointer, the controller including an image sensor receiving the light beam to obtain an image frame having a light spot; and a coordinate transformation processor calculating a first coordinate of the light spot in a first coordinate system and transforming the first coordinate into a second coordinate of a predetermined second coordinate system; wherein the image display shows the pointer at a position in the displayed image corresponding to the second coordinate.

In the foregoing optical pointer control system, the light beam generated by the light source preferably has a specific wavelength. The image sensor preferably includes a filter allowing light with the specific wavelength to pass through.

In one embodiment of the foregoing optical pointer control system, the first coordinate system is defined by resolution of the image frame outputted from the image sensor.

In one embodiment of the foregoing optical pointer control system, the second coordinate system is defined by resolution of the image outputted from the image display.

The foregoing optical pointer control system preferably further comprises a host driving the image display to show the image, wherein the coordinate transformation processor is wholly disposed in the host, or partially disposed in the host and partially disposed in the controller.

In the foregoing optical pointer control system, the host and the controller may communicate with each other in a wireless way or a wired way.

In yet another aspect, the present invention provides an operation method of an optical pointer control system, controlling a position of a pointer in a displayed image, comprising: receiving at least one light beam generated from the system to obtain an image frame having a light spot; calculating a first coordinate of the light spot in a first coordinate system and transforming the first coordinate into a second coordinate of a predetermined second coordinate system; and showing the pointer at a position in the displayed image corresponding to the second coordinate.

The objectives, technical details, features, and effects of the present invention will be better understood with regard to the detailed description of the embodiments below, with reference to the drawings.

### BRIEF DESCRIPTION OF THE DRAWINGS

FIG. 1 shows a schematic diagram illustrating an optical pointer control system of the present invention.

FIG. 2 shows a schematic diagram illustrating the visual field angles of a controller when receiving the light from a light source.

FIGS. 3A and 3B show two image frames captured by the image sensor from the two visual field angles in FIG. 2.

FIG. 4 shows a schematic diagram illustrating an image display on which the movement of the cursor is controlled by the controller in FIG. 2.

### DESCRIPTION OF THE PREFERRED EMBODIMENTS

The present invention is applicable to computers, video players or interactive game systems, such as for moving a pointer on a display of a computer monitor, remote-control of a video player, remote-control of a smart TV, etc. The pointer maybe a cursor or a movable object shown on a display or a monitor. The types of the cursor may be an arrow, an I shape, a cross shape, a hand icon or other controllable position marks represented by any shapes.

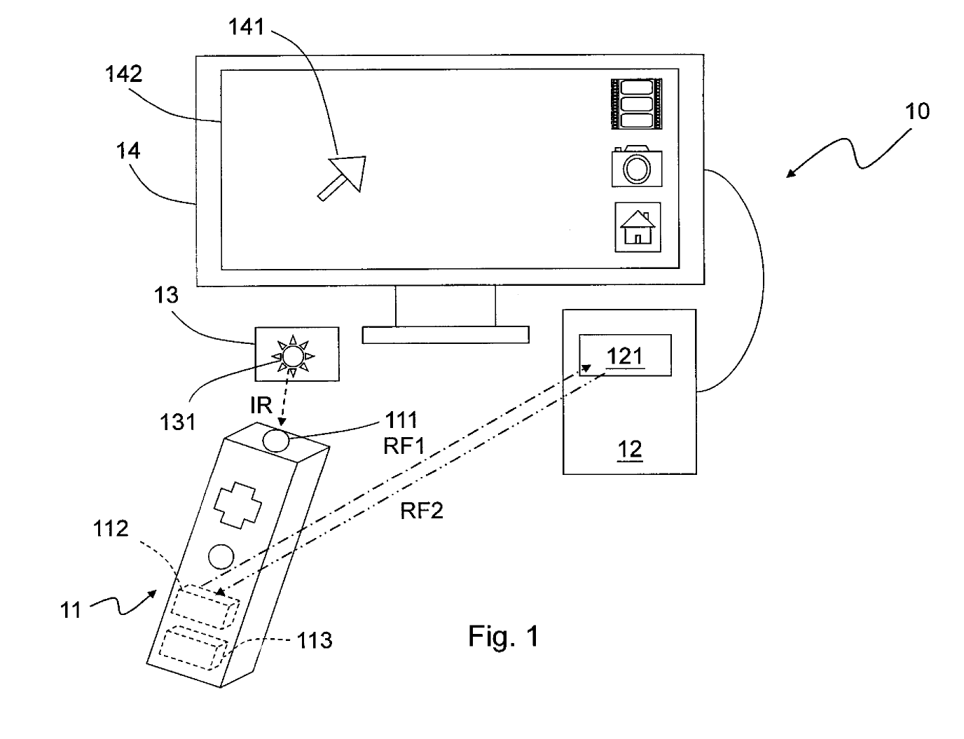

FIG. 1 shows a schematic diagram illustrating an optical pointer control system of the present invention. As shown in this figure, an optical pointer control system 10 substantially comprises a controller 11, a host 12, a light source 13 and an image display 14. The host 12 executes a video game program or a video program, displaying images by the image display 14. The image display 14 may be an image screen, a projector, a head-mounted display, or other types of display apparatuses. A user operates the controller 11 to interact with the host 12 such that the host 12 executes various actions or instructions such as moving a pointer or a cursor 141 on the image display 14 to the menu at the right side. The light source 13 shown in this embodiment only has a single lighting unit 131, but in other embodiments, the light source 13 may include multiple lighting units 131.

When the controller 11 is operated by the user, the lighting unit 131 of the light source 13 generates an infrared (IR) ray which is imaged in the image sensor 111 of the controller 11. That is, the image sensor 111 captures an image frame having a light spot formed by the IR ray. The light source 13/lighting unit 131 preferably has a specific wavelength. In one embodiment, the image sensor 111 includes a filter allowing light with the specific wavelength to pass through. The processor 113 calculates a first coordinate of the light spot in the first coordinate system of the captured image frame, and the first coordinates is transferred into a second coordinate of a predetermined second coordinate system defined by the display 14, that is, the second coordinate system is defined by the resolution of the image displayed on the image display 14. The image display 14 shows the cursor 141 on the displayed image 142 according to the second coordinate. In this embodiment, the processor 113 is disposed in the controller 11; in other embodiments, it can be disposed in the host 12. The host 12 includes a transceiver 121, which communicates with the transceiver 112 of the controller 11 through the radio frequency signals RF1 and RF2 (or IR signals) for bidirectional data transmission. In other embodiments, the data transmission can be conducted in a wired way.

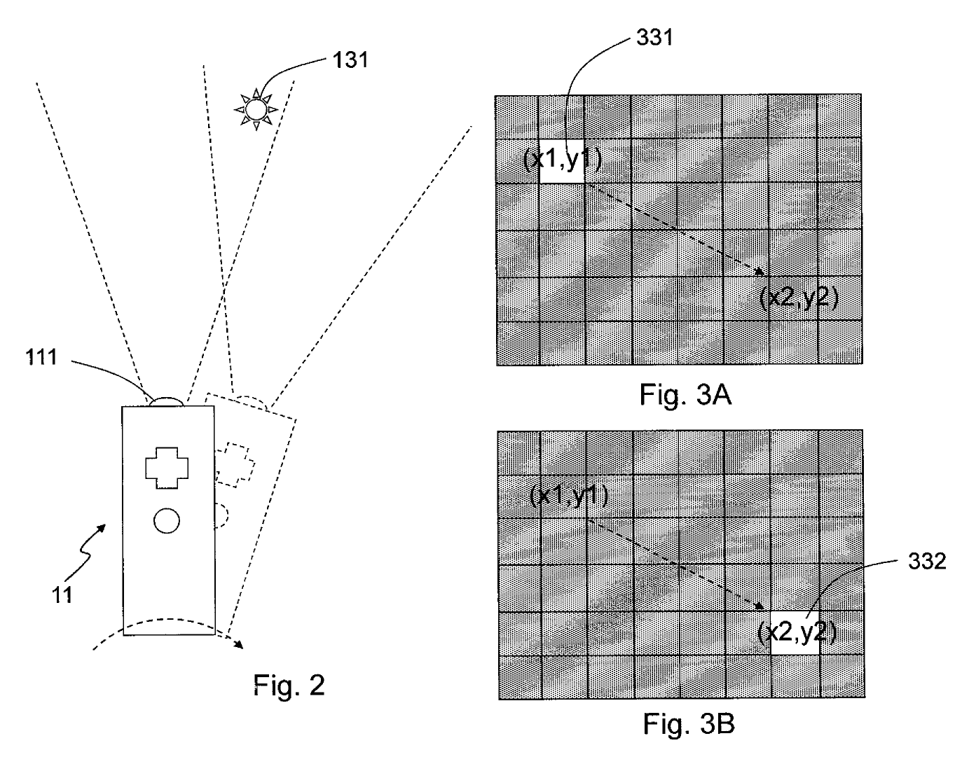

FIG. 2 shows a schematic diagram illustrating the visual field angles of a controller when receiving the light from a light source. As shown in this figure, when the user rightward moves or clockwise rotates the controller 11, the lighting unit 131 is relatively moved from the right side to the left side of the visual field angle of the image sensor 111. Referring to FIG. 3A and FIG. 3B, the image sensor 111 captures two image frames according to the different visual field angles at different positions. So, the light spot 331 at the coordinate (x1, y1) moves to the coordinate (x2, y2) as indicated by the reference number 332. The coordinates in this coordinate system is obtained according to the resolution of the image sensor 111. For example, the resolution of the image sensor 111 is 256×256. The coordinate of the pixel where the light spot covers represents the position. The coordinate system of the image sensor 111 is referred to as the first coordinate system herein. To simplify the mapping transformation, in one embodiment, the xy coordinate system in FIG. 3A and FIG. 3B can be defined as a coordinate system rotating 180 degrees from the normal coordinate system. That is, the coordinate along the horizontal direction increases from the right side to the left side, and the coordinate along the vertical direction increases from the upper side to the lower side. Or alternatively, as shown in the present embodiment, the image sensor 111 is rotated by 180 degrees as it captures images. The present invention has the follow features and advantages: because coordinate of the pixel where the light spot covers represents the position, no complicated calculation is required to identify features in an image, and it is not necessary to compare a feature in a previous image frame with the feature in a next image frame to determine a relative displacement and moving direction. What the present invention generates is an absolute coordinate. In this embodiment, the size of the light spot covers only one pixel. In other embodiments, the light spot may cover multiple pixels; in this case the representative coordinate of the light spot may be the geometric center or the weighted gravity center of the multiple pixels, or the coordinate of any of the pixels.

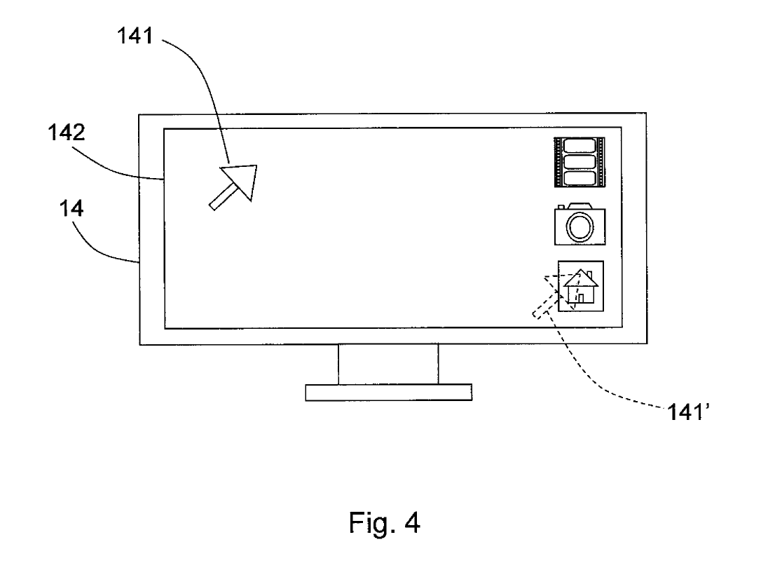

FIG. 4 shows a schematic diagram illustrating an image display on which the movement of the cursor is controlled by the controller in FIG. 2. Referring to this figure, the cursor 141 in the displayed image 142 on the image display 14 moves from the coordinate (x1′ , y1′) close to the upper left corner to the coordinate (x2′, y2′) as indicated by the reference number 141′. The coordinate (x1′, y1′) is directly mapped or transferred from the coordinate (x1, y1) in FIG. 3A. Similarly, the coordinate (x2′, y2′) is directly mapped or transferred from the coordinate (x2, y2) in FIG. 3B. The coordinate system of the image display 14 is referred to as the second coordinate system. A resolution is set to or selected for the image display 14—1024×768 for example. If the processor 113 knows the resolution of the image display 14 in advance, the coordinates (x1, y1) and (x2, x2) are directly mapped or transferred to the coordinates (x1′, y1′) and (x2′, x2′), for example by moving average, interpolation, or other methods. If the processor 113 is disposed in the controller 11 and it cannot know the resolution of the image display 14 in advance, it can simply output the coordinates (x1, y1) and (x2, x2) of the first coordinate system. Then, a processor of the host 12 can transfer the first coordinate system of the image sensor 111 to the second coordinate system of the image display 14. As such, the coordinates of the light spot captured by the image sensor 111 are mapped to the corresponding coordinates of the second coordinate system in a very easy way, without complicated calculation. In the foregoing description, the processor 113 and the processor in the host 12 can be considered as an overall coordinate transformation processor partially disposed in the controller 11 and partially disposed in the host 12. That is, the coordinate transformation processor can be completely deposed in the controller 11 (the processor 113 is disposed in the controller 11 and functions as the coordinate transformer), completely deposed in the host (the processor 113 is disposed in the host 12 and functions as the coordinate transformer) or partially disposed in the controller 11 and partially disposed in the host 12 (the process 113 and the processor of the host 12 cowork to function as the coordinate transformer).

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. For example, the host 12 may be a game host, a video player or a smart TV. For another example, the processor 113 is shown to be disposed in the controller 11 in the drawing, but it can be disposed in the host 12 or in other parts or locations of the system. The light source 13 can include multiple lighting units 131 that form one light spot together, or form multiple light spots in the image sensor 111. In the latter case, the coordinate of each of the light spots can be directly transferred to a corresponding coordinate on the image display by the foregoing method, for use to control multiple pointers or cursors. Thus, the present invention should cover all such and other modifications and variations, which should be interpreted to fall within the scope of the following claims and their equivalents.

What is claimed is:

1. An optical pointer control system, comprising:
an image display showing an image including a pointer;
a light source generating at least one light beam;
a controller controlling a position of the pointer, the controller including an image sensor receiving the light beam to obtain an image frame having a light spot; and
a coordinate transformation processor calculating a first coordinate of the light spot in a first coordinate system and transforming the first coordinates into a second coordinate of a second coordinate system;
wherein the image display shows the pointer at a position in the displayed image corresponding to the second coordinate.

2. The optical pointer control system of claim 1, wherein the light source generates a plurality of light beams and the image display shows a plurality of controllable pointers.

3. The optical pointer control system of claim 1, wherein the light beam generated by the light source has a specific wavelength.

4. The optical pointer control system of claim 1, wherein the image sensor includes a filter allowing light with a specific wavelength to pass through.

5. The optical pointer control system of claim 1, wherein the coordinate transformation processor is disposed in the controller.

6. The optical pointer control system of claim 1, wherein the first coordinate system is defined by resolution of the image frame outputted from the image sensor.

7. The optical pointer control system of claim 1, wherein the second coordinate system is defined by resolution of the image outputted from the image display.

8. The optical pointer control system of claim 1, further comprising a host driving the image display to show the image, wherein the coordinate transformation processor is wholly disposed in the host, or partially disposed in the host and partially disposed in the controller.

9. The optical pointer control system of claim 8, wherein the host and the controller communicate with each other in a wireless way or a wired way.

10. The optical pointer control system of claim 1, wherein the light spot only occupies one pixel in the image frame and the first coordinate is a coordinate of the pixel.

11. The optical pointer control system of claim 1, wherein the light spot occupies multiple pixels in the image frame and the first coordinate is a coordinate of a geometric center or a weighted gravity center of the multiple pixels, or a coordinate of any of the multiple pixels.

12. An operation method of an optical pointer control system, for controlling a position of a pointer in a displayed image, comprising:
receiving at least one light beam generated from the system to obtain a image frame having a light spot;
calculating a first coordinate of the light spot in a first coordinate system and transforming the first coordinate into a second coordinate according to a predetermined second coordinate system; and
showing the pointer at a position in the displayed image corresponding to the second coordinate.

13. The operation method of an optical pointer control system of claim 12, wherein the first coordinate system is defined by resolution of the image frame outputted from an image sensor, and the image sensor receives the light beam to obtain the image frame.

14. The operation method of an optical pointer control system of claim 12, wherein the second coordinate system is defined by resolution of the image outputted from the image display.

15. The operation method of an optical pointer control system of claim 12, wherein the light source generates a plurality of light beams and the image display shows a plurality of controllable pointers.

16. The operation method of an optical pointer control system of claim 12, wherein the light spot only occupies one pixel in the image frame and the first coordinate is a coordinate of the pixel.

17. The operation method of an optical pointer control system of claim 12, wherein the light spot occupies multiple pixels in the image frame and the first coordinate is a coordinate of a geometric center or a weighted gravity center of the multiple pixels, or a coordinate of any of the multiple pixels.
